(19) United States
(12) Patent Application Publication
(10) Pub. No.: US 2017/0313617 A1
(43) Pub. Date: Nov. 2, 2017

(54) METHOD AND APPARATUS FOR LASER-CUTTING OF TRANSPARENT MATERIALS

(71) Applicant: Coherent, Inc., Santa Clara, CA (US)

(72) Inventors: Michael GREENBERG, Santa Rosa, CA (US); David GAUDIOSI, Rohnert Park, CA (US); Derek DECKER, Santa Clara, CA (US); Jochen DEILE, Santa Clara, CA (US); John H. JERMAN, Palo Alto, CA (US)

(21) Appl. No.: 15/140,371

(22) Filed: Apr. 27, 2016

(51) Int. Cl. C03B 33/09; B23K 26/06; B23K 26/0622; B23K 26/00; B23K 26/08; B23K 103/00

(52) U.S. Cl. CPC C03B 33/091; B23K 26/083; B23K 26/0648; B23K 26/0643; B23K 26/0624; B23K 26/0006; B23K 26/0057; B23K 2203/54

(57) ABSTRACT

A method for cutting a transparent brittle material using pulsed laser-radiation is disclosed. A beam of pulsed laser-radiation having an optical-axis is focused in the material by a variable-focus lens or mirror. The focus is translated along the optical-axis while the material is moved with respect to the beam to create an array of defects along a cutting path.

### TECHNICAL FIELD OF THE INVENTION

The present invention relates in general to cutting transparent materials using a beam of laser-radiation. The invention relates in particular to cutting transparent brittle materials using a focused beam of ultra-short laser-radiation pulses, for example, pulses having a duration of about 20 picoseconds (ps) or less.

### DISCUSSION OF BACKGROUND ART

Laser material-processing is increasingly used for cutting, drilling, marking, and scribing a wide range of materials, including brittle materials such as glass and sapphire. Traditional mechanical processing produces unwanted defects, such as micro cracks that may propagate when the processed material is stressed, thereby degrading and weakening the processed material. Laser-processing of brittle materials using a focused beam of pulsed laser-radiation produces precise cuts and holes, having high-quality edges and walls, while minimizing the formation of unwanted defects. Progress in scientific research and manufacturing is leading to laser-processing of an increasing range of brittle materials, while demanding increased processing speed and precision.

Transparent brittle materials interact with focused beams of pulsed laser-radiation through non-linear absorption of the laser-radiation. The pulsed laser-radiation may comprise a train of individual pulses, or rapid bursts of pulses. Each individual pulse or burst of pulses creates a defect in the transparent brittle material at the focus of the beam.

A material is cut by translating the focused beam through the material to create a row of defects along a cutting line. In general, an optimized process creates discrete, spatially-separated defects in the material, and does not allow the defects to overlap. However, contemporary sources of ultra-short pulsed laser-radiation deliver pulses at repetition rates of more than a few hundred kilohertz (kHz). Such high pulse-repetition rates would create overlapping defects in the material, even at the maximum translation and scanning speeds accessible with contemporary laser machine-tools.

In order to achieve an optimum spacing between defects, it is necessary to limit the pulse-repetition rate by selectively eliminating pulses from the train thereof delivered by the laser. This is commonly referred to as “pulse-picking” by practitioners of the art. Such pulse-picking, however, reduces average power of laser-radiation delivered to the material, thereby reducing processing speed, and under-utilizing the capabilities of the source of pulsed laser-radiation.

A defect in glass produced by focused pulsed laser-radiation, typically extends into the glass for a few tens of micrometers (μm) in depth, whereas stock sheet-glass for consumer devices typically has a thickness between about 300 μm and 1.1 millimeters (mm). In order to cut through the full thickness of a stock sheet, the focused beam is scanned along the cutting line a plurality times at different depths-of-focus, thereby creating parallel rows of defects extending through the sheet. Many tens of passes may be required for a full cut, which constrains the productivity of apparatus used for the cutting.

Longer defects, requiring fewer passes, can be created by using extended foci of aberrated beams or Bessel beams. However, such extended foci contain a fraction of the incident average power, which diminishes cutting efficiency, and extended foci may have satellite structure, which can result in poor quality of a cut edge.

There is a need for a laser-cutting method for transparent brittle materials that utilizes the high pulse-repetition rates of contemporary ultra-short pulsed lasers to increase the productivity of laser-cutting apparatus. Preferably, this productivity increase should be achieved without sacrificing quality of cut edges.

### SUMMARY OF THE INVENTION

In one aspect, a method is disclosed for cutting a workpiece along a cutting path using a beam of pulsed laser-radiation from a source thereof in accordance with the present invention. The beam of pulsed laser-radiation has an optical-axis. The beam of pulsed laser-radiation is focused to a focus-location on the optical-axis. The method comprises translating the focus-location along the optical-axis between first and second opposite surfaces of the workpiece, while moving the workpiece continuously in a plane transverse to the optical-axis such that the optical-axis follows the cutting path. Translating the focus-location within the moving workpiece creates a two-dimensional array of defects within the workpiece.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1A schematically illustrates one preferred embodiment of a cutting method in accordance with the present invention, for creating an array of defects in a workpiece of a transparent material along a cutting path using a focused beam of pulsed laser-radiation, the focused beam having a selectively variable focus-location in the workpiece.

FIG. 1B and 1C form a timing diagram schematically illustrating a scheme for creating the array of defects of FIG. 1A.

FIG. 2 is a block diagram schematically illustrating one preferred embodiment of apparatus in accordance with the present invention for implementing the laser-cutting method of the present invention, the apparatus including a laser source for delivering a beam of pulsed laser-radiation, a variable-focus lens cooperative with an objective lens for focusing the beam at a selectively variable focus-location in a workpiece to be cut.

FIG. 3A schematically illustrates another preferred embodiment of a cutting method in accordance with the present invention, for creating an array of defects in a workpiece of a transparent material.

FIG. 3B schematically illustrates yet another preferred embodiment of cutting method in accordance with the present invention, for creating an array of defects in a workpiece of a transparent material.

FIG. 3C schematically illustrates still another preferred embodiment of cutting method in accordance with the present invention, for creating an array of defects in a workpiece of a transparent material.

FIG. 4A and 4B form a timing diagram schematically illustrating a scheme for creating the array of defects of FIG. 3B.

FIG. 4C and 4D form a timing diagram schematically illustrating a scheme for creating the array of defects of FIG. 3C.

FIG. 5 is a block diagram schematically illustrating another preferred embodiment of apparatus in accordance with the present invention, similar to the embodiment of FIG. 2, but wherein the variable-focus lens is replaced by a variable-focus mirror.

FIG. 6A is a plan view schematically illustrating one preferred example of the variable-focus mirror of FIG. 5.

FIG. 6B is a side-elevation view further schematically illustrating the variable-focus mirror of FIG. 6A.

### DETAILED DESCRIPTION OF THE INVENTION

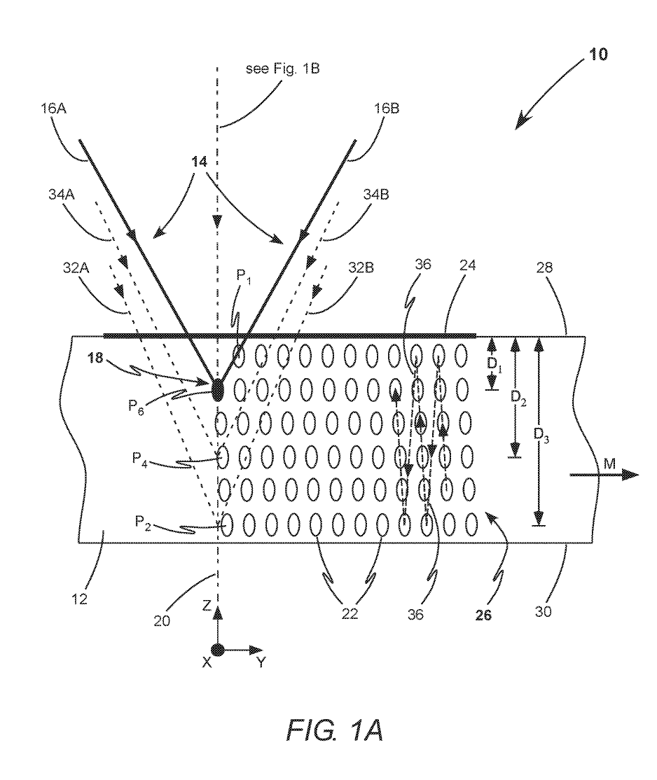

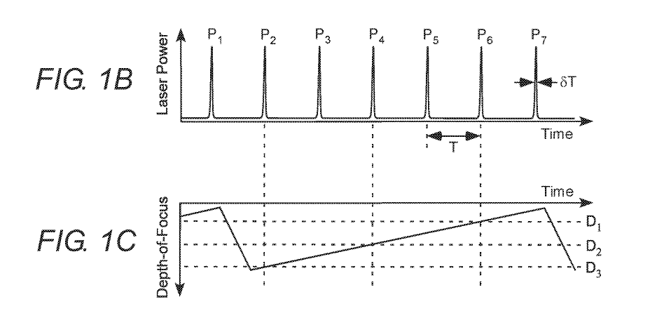

Referring now to the drawings, wherein like components are designated by like numerals, FIG. 1A schematically illustrates one preferred embodiment 10 of a laser-cutting method in accordance with the present invention. Here, the method comprises cutting a workpiece 12 of a transparent brittle material using a focused beam of laser-radiation 14. Laser-radiation 14 has a wavelength at which the material is transparent. The inventive method is applicable to any non-pliable material transparent at the laser-wavelength, such as glass or sapphire.

Focusing of beam 14 in workpiece 12 is indicated by converging rays 16A and 16B, representing boundary rays of the focused beam of laser-radiation. The focused beam of laser-radiation converges to a focus-location 18 on optical-axis 20 of beam 14. The laser-radiation has an electric-field which is strongest at focus-location 18. Pulsing the focused beam of laser-radiation further increases the electric-field strength at the focus-location.

The inventive method requires that the electric-field strength at focus-location 18 exceeds an interaction threshold characteristic of the particular material of workpiece 12. When the electric-field strength exceeds the interaction threshold, there will be a permanent modification of the material where the focused beam of laser-radiation interacts with the material. A permanent material modification may include cracking, material removal, a change in material density, or creation of a void within the workpiece.

A preferred pulse-duration for pulses in the laser-radiation beam is less than about 20 ps. Optical pulses of more than about 1 nanosecond (ns) transfer heat energy to the material causing unwanted collateral damage. For optical pulses less than about 20 ps, material modification occurs through non-thermal processes, which reduce or altogether avoid collateral damage. A permanent material modification made by a pulse arriving at focus-location 18 can be referred to as a defect 22 in the material of the workpiece.

FIG. 1B is a graph schematically illustrating power in the focused beam of pulsed laser-radiation as a function of time. Each peak corresponds to an individual pulse within beam 14. Pulses are labeled consecutively, starting from a pulse identified as “P₁”. Each pulse has a pulse-duration (δT), as indicated in FIG. 1B for pulse P₇. Pulse-duration δT is preferably less than about 20 ps, as discussed above. Pulse-repetition rate is inversely proportional to the time-interval (T) between successive pulses. The pulse-repetition rate is preferably greater than about 100 kHz. The pulses have a peak power that is proportional to the square of the peak electric-field strength of the pulses.

Referring again to FIG. 1A, workpiece 12 is moving in a plane transverse to the optical-axis through a stationary, focused beam of laser-radiation. An x, y, and z Cartesian axis system is included in FIG. 1A for facilitating the following description. The motion of the workpiece is indicated by the vector M. Alternatively, the focused laser beam may be moved through a stationary workpiece. In either case, the motion creates defects in workpiece 12 following a cutting path 24 indicated in FIG. 1A by a bold line. A two-dimensional array 26 of such defects is created by translating focus-location 18 along optical-axis 20 between an entrance-surface 28 and an opposite exit-surface 30 of the moving workpiece. Defects created by pulses P₁, P₂, P₄, and P₆ are indicated in FIG. 1A using the pulse labeling of FIG. 1B. Pulse P₁ was applied to the moving workpiece while the focus-location was close to surface 28, thereby creating a subsurface defect close to surface 28. Between applying pulse P₁ and pulse P₂, the focus-location was translated rapidly along optical-axis 20 towards surface 30, pulse P₂ thereby creating a subsurface defect close to surface 30. During subsequent pulses the focus-location is translated along the optical-axis at the velocity required to create the optimum spacing between defects in the z-direction. Meanwhile, the workpiece is continuously moved in a x-y plane with the velocity required to create the optimum spacing between defects in the y-direction.

Depth-of-focus is defined herein as the distance between surface 28 and the focus-location. The focused beam of pulsed laser-radiation when P₂ was applied is depicted in FIG. 1A as two (dashed) rays, 32A and 32B, converging at a depth-of-focus D₃. The focused beam of pulsed laser-radiation when P₄ was applied is depicted as two (dashed) rays, 34A and 34B, converging at a depth-of-focus D₂. FIG. 1A depicts the location of workpiece 12 with respect to beam 14 at the moment a defect (shaded) is created by pulse P₆. Rays 16A and 16B converge at a depth-of-focus D₁. Pulse P₇ will create another subsurface defect close to surface 28, then the focus-location will again be translated rapidly along the optical-axis to the depth close to surface 30, thereby repeating the pattern traced by the focus-location.

FIG. 1C is a graph schematically illustrating depth-of-focus as a function of time, which has a saw-tooth shape that repeats while the workpiece is continuously moved. FIG. 1B and 1C together form a timing diagram schematically illustrating synchronization between the application of laser pulses and the depth-of-focus in the moving workpiece. Pulse P₂ was applied when the depth-of-focus was D₃, P₄ was applied when the depth-of-focus was D₂, and pulse P₆ is applied when the depth-of-focus is D₁. Consequently, defects are created sequentially following a saw-tooth pattern through the moving workpiece, using all of the pulses in beam 14. Such a saw-tooth pattern 36 for creating defects 22 is indicated in FIG. 1A by a (dashed) arrowed line.

Moving workpiece 12 in the direction opposite to vector M would create a mirrored array of defects having a saw-tooth pattern. However, reversing the direction of motion may produce an inferior result in materials where antecedent defects absorb or scatter the focused beam of pulsed laser-radiation.

Once array 26 of defects 22 has been created, the workpiece may separate spontaneously along cutting line 24. Otherwise, the workpiece may be separated by applying mechanical or thermal stress. Applying a second beam of laser radiation along the cutting line is one controlled way to apply stress and minimize damage to edges created by separation.

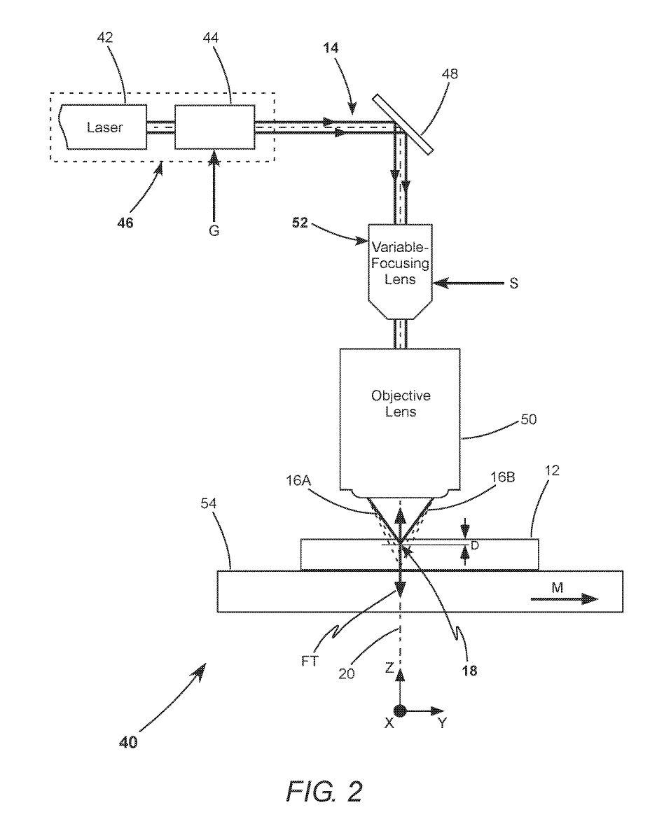

FIG. 2 schematically illustrates one preferred embodiment 40 of laser-cutting apparatus in accordance with the present invention. Apparatus 40 includes laser 42 that delivers a beam of pulsed laser-radiation 14. An optional pulse-picker 44 is arranged to intercept beam 14. Together, the source of laser-radiation and the optional pulse-picker are a gated source of pulsed laser-radiation 46. An exemplary gated source of ultra-fast ultra-short pulsed laser-radiation suitable for this application is Monaco™ from Coherent Inc. of Santa Clara Calif., which has an output wavelength of 1035 nanometers (nm), where most types of glass are transparent. Monaco™ has average output power up to about 40 W (Watts), adjustable repetition rate from single-shot to 1 megahertz (MHz), adjustable pulse duration from 400 fs (femtoseconds) to 10 ps, and beam-quality M² less than 1.2.

Apparatus 40 further includes at least one optional mirror 48 to steer beam 14 into an objective lens 50. Those skilled in the art of optical design would recognize that any optics required for steering beam 14 from the source of laser-radiation into the objective lens could be customized as necessary, without departing from the spirit and scope of the present invention.

A variable-focus lens 52 is arranged to intercept beam 14 between gated source of pulsed laser-radiation 46 and objective lens 50. Lens 52 has an optical power (reciprocal of focal length) that is regulated by an electrical drive signal indicated by an arrow (S). A gate-signal (G) is provided to pulse-picker 44 to allow for synchronous operation of lens 52 and laser-radiation source 46. Such synchronous operation is described in detail further hereinbelow.

Objective lens 50 and variable-focus lens 52 together focus the beam of pulsed laser-radiation to focus-location 18 along optical-axis 20. Depth-of-focus (D) in workpiece 12 is regulated by drive signal S. A translation stage 54 supports and moves workpiece 12.

Translation of focus-location 18 along optical-axis 20 is indicated in FIG. 2 by a double-headed arrow (FT). Cutting is accomplished by moving the transparent material in a x-y plane, thereby tracing the optical-axis along cutting path 24, while applying drive signal S to achieve the saw-tooth modulation of depth-of-focus depicted in FIG. 1C. A saw-tooth pattern of defects is thereby created along the cutting path, as depicted in FIG. 1A.

Variable-focus lens 52 preferably translates the focus-location along optical-axis 20 with sufficient velocity to avoid defects created by successive pulses from overlapping. One suitable lens for lens 52 is a “TAG Lens™” commercially available from TAG Optics Inc. of Princeton N.J. This lens includes an aspheric optical lens element generated in a liquid medium through density modulations created by piezoelectric (PZT) transducers that are driven by an oscillating electric potential. These features are not depicted in FIG. 2 for simplicity of illustration.

In the TAG Lens™, the oscillating electric potential has a sinusoidal waveform with a peak-to-peak voltage of up to 50 Volts (V) and a frequency range from 70 kHz to 1.0 MHz. By way of example, at 10 V and 515 kHz the optical power is modulated sinusoidally between −10 Diopters (m⁻¹) and 10 m⁻¹. Utilizing this lens as lens 52 and a 125 m⁻¹ commercially available objective lens as lens 50, the depth-of-focus in fused silica glass with a refractive index of 1.45 at 1035 nm would be modulated sinusoidally by 1.87 mm peak-to-peak at a driving frequency of 515 kHz.

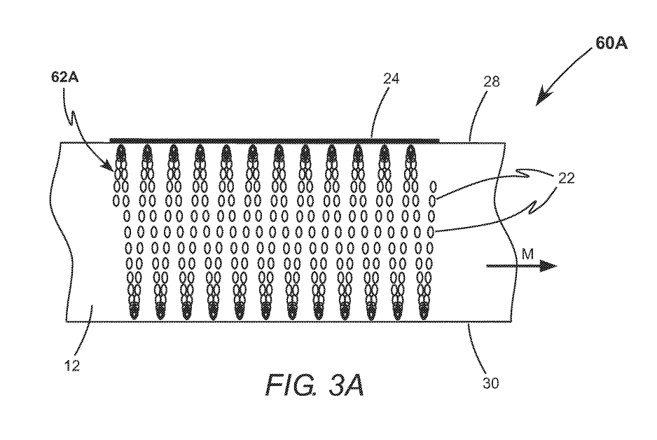

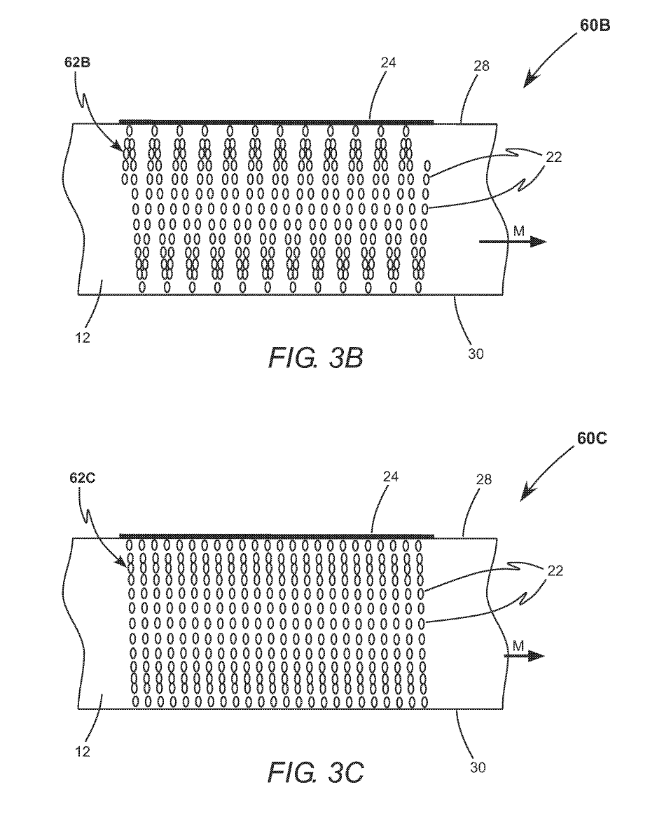

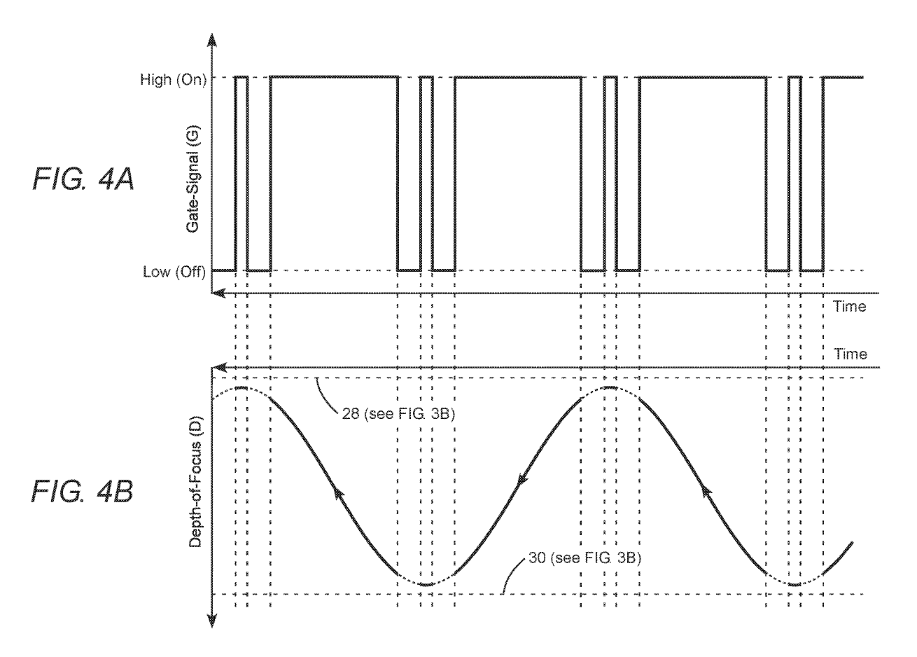

Lens 52 can be operated synchronously with the source of pulsed laser-radiation or asynchronously. A description of examples of asynchronous and synchronous operation of lens 52 is set forth below with reference to FIG. 3A, FIG. 3B, and FIG. 3C, and with reference in addition to FIG. 2.

FIG. 3A schematically illustrates another preferred embodiment 60A of a cutting method in accordance with the current invention for creating a two-dimensional array 62A of defects 22 along cutting path 24 in asynchronous operation, using all pulses delivered by laser-radiation source 46 of FIG. 2. Array 62A is sinusoidal in form, with a higher density of defects near surfaces 28 and 30, and a lower density of defects deep inside workpiece 12. The higher density of defects near the surfaces may produce unacceptable edge-quality when cutting certain materials.

FIG. 3B schematically illustrates yet another preferred embodiment 60B of a cutting method in accordance with the current invention. Here, synchronous operation of lens 52 and laser-radiation source 46 is used to create an approximately uniform density of non-overlapping defects 22 in an array 62B thereof. This is achieved by selectively gating off (eliminating) pulses from laser 42 of laser-radiation source 46 using pulse-picker 44 thereof (see FIG. 2) to reduce the density of defects nearer the surfaces. In the example depicted, 25% of the pulses from the source of pulsed laser-radiation are eliminated by the pulse-picker, or equivalently, 75% of the pulses from laser 42 of source 46 are utilized.

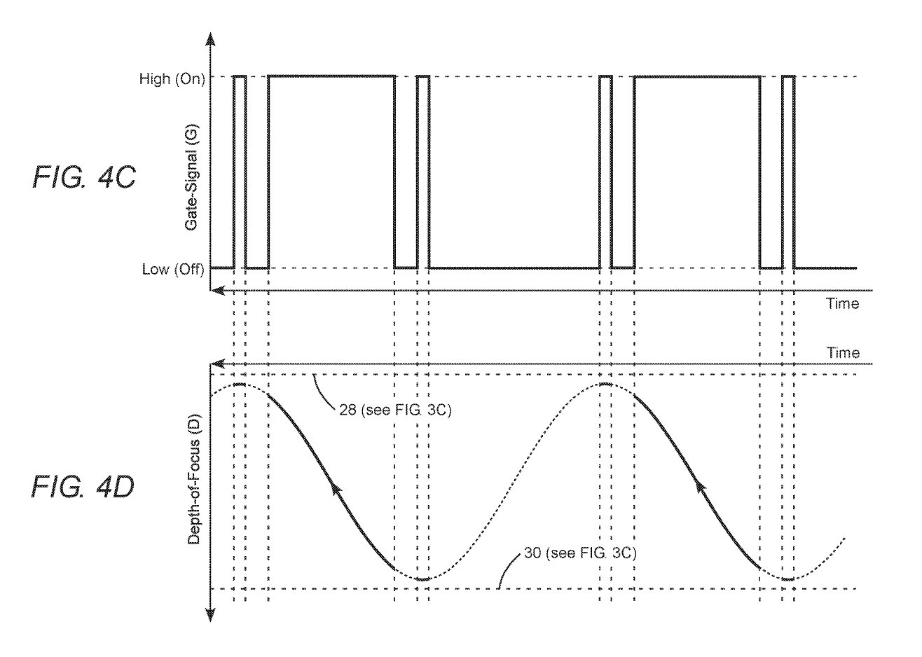

FIG. 4A and FIG. 4B form a timing diagram schematically illustrating a scheme for synchronously gating pulses to create array of defects 62B of FIG. 3B. FIG. 4A depicts gate-signal G (see FIG. 2) as a function of time. FIG. 4B depicts depth-of-focus D within workpiece 12 as a function of time. It should be noted that time progresses from right to left in FIG. 4A and 4B in order to aid comparison to FIG. 3B. Pulses are delivered to the workpiece only while gate-signal G is at logic “high”. Depths-of-focus at which the pulses are delivered are along portions of the curve of FIG. 4B indicated in bold line.

FIG. 3C schematically illustrates still another preferred embodiment 60C of a cutting method in accordance with the current invention. This method is similar to the method of FIG. 3B, with an exception that an array 62C of defects is created by gating off a higher percentage of pulses from laser 42. Array 62C has approximately the preferred saw-tooth pattern of array 26 of FIG. 1A. In order to achieve this pattern, pulses from laser 42 are gated off by pulse-picker 44 as in the example of FIG. 3B and for half of each cycle of lens 52, while workpiece 12 moves at half the velocity that is assumed in the examples of FIG. 3A and 3B. In the example depicted in FIG. 3C, 59% of the pulses from the source of pulsed laser-radiation are eliminated by the pulse-picker or equivalently 41% of the pulses are utilized.

FIG. 4C and FIG. 4D form a timing diagram schematically illustrating a scheme for synchronously gating pulses to create the array of defects 62C of FIG. 3C. Here again, pulses are only delivered to the workpiece while gate-signal G is at logic “high”. Pulses are gated in the same manner as FIG. 4A, with an exception that gate signal G is at logic “low” for half of each cycle of the variable-focus lens, that is while the depth-of-focus is translated away from surface 28 and toward surface 30. No defects are generated during the half cycle that gate signal G is “low”. Depths of focus at which pulses are delivered are indicated along the curve of FIG. 4D in bold line.

By way of example, to cut through a 700 μm thick workpiece of fused silica using a 3 MHz source of pulsed laser-radiation and a 125 m⁻¹ objective lens to create the array of defects 62C of FIG. 3C. Assuming an average center-to-center separation between the defects of about 50 μm along the Z-axis and about 20 μm along the Y-axis, the variable-focus lens would be modulated by 7 m⁻¹ peak-to-peak at a frequency of about 95 kHz, while moving the workpiece at about 2 meters per second (m/s). 2 m/s is a typical maximum translation speed for a state-of-the-art industrial linear translation stage. An array of defects along a 300 mm cut line would be created in about 150 milliseconds (ms) using the inventive method, compared to more than 2 seconds to create an array of defects having the same average density by making a plurality of passes at fixed depths-of-focus. The 2 second processing time is based just on the number of passes required and does not take into account any additional dwell times required between passes.

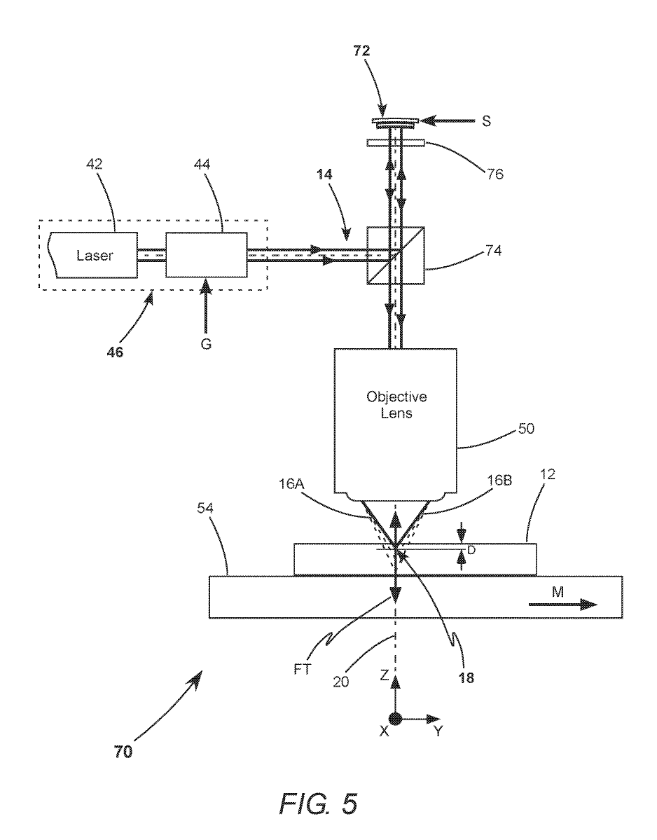

FIG. 5 schematically illustrates another preferred embodiment 70 of laser-cutting apparatus in accordance with the present invention. Apparatus 70 is similar to apparatus 40 of FIG. 2, with an exception that a variable-focus mirror 72 replaces variable-focus lens 52.

Apparatus 70 further includes a polarization beam splitter 74 that intercepts beam 14 and directs beam 14 through a quarter-wave plate 76 and onto variable-focus mirror 72. Mirror 72 has optical power that is regulated by the drive signal (S). Mirror 72 reflects beam 14 back through quarter-wave plate 76, through polarization beam splitter 74 and into objective lens 50. The variable-focus mirror and the objective lens together focus the beam of pulsed laser-radiation to the focus-location 18 along optical-axis 20. The depth-of-focus (D) in moving workpiece 12 is regulated by drive signal S.

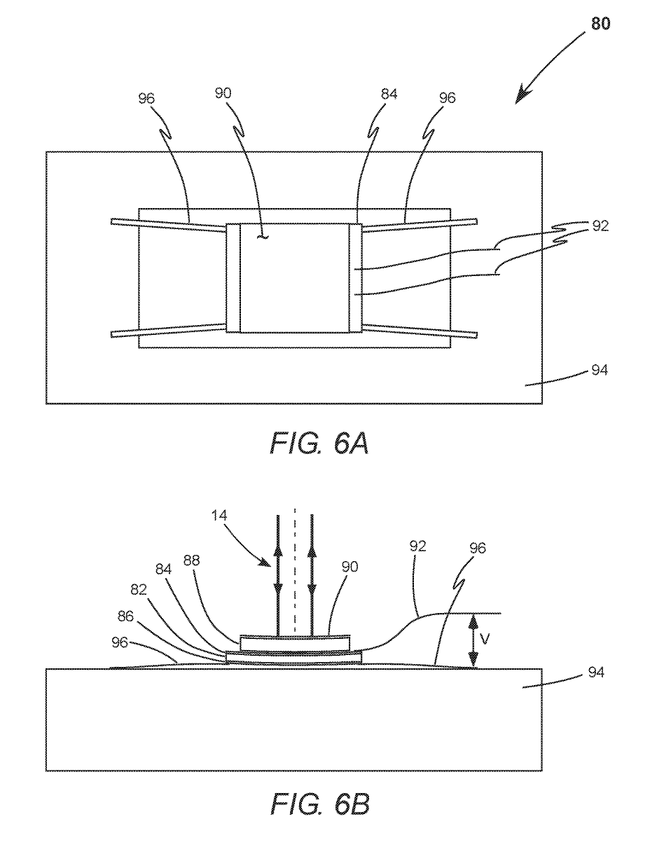

FIG. 6A and 6B schematically illustrate one preferred example 80 of variable-focus mirror apparatus in accordance with the present invention. Apparatus 80 includes a single PZT element 82, having a first-side nickel coating 84 and a second-side nickel coating 86. The coated PZT element preferably has dimensions 4 mm×5 mm×250 μm. The nickel coatings are electrodes that enable direct soldering for mechanical and electrical connection. First-side nickel coating 84 is overlaid with a layer 88 of silicon, preferably having dimensions 4 mm×4 mm×300 μm. Silicon layer 88 is overlaid with a mirror-coating 90 that is reflective at the wavelength of the beam of laser-radiation. One or more wires 92 provide electrical connection to exposed nickel on first-side nickel coating 84. Second-side nickel coating 86 is attached to a rigid mount 94 at each corner thereof by four cantilever flexures 96. Together, the four cantilever flexures enable the mirror-coated PZT element to freely deform, and provide electrical connection to exposed nickel on second-side nickel coating 86. PZT element 82 and mirror-coating 90 thereon deform when an electric potential (V) is applied across PZT element 82. A significant fraction of the deformed mirror surface, extending from the center thereof out towards the edges, has a spherical surface configuration. Mirror 80 would be arranged to intercept laser-radiation 14 near the center of the deformed mirror surface.

Given the exemplary materials and dimensions discussed above, device 80 would have a capacitance of approximately 200 nanoFarad (nF) and would take approximately 4 microseconds (μs) to respond and settle after a stepwise change in applied electric potential of 100 V. At 0 V, the mirror surface would be flat, and at +100 V the mirror surface would have a radius of curvature of approximately 1 meter (m) or equivalently an optical power of 2m⁻¹. Modulation of the optical power with larger amplitudes could be achieved by driving the device with a sinusoidal waveform having a frequency near the fundamental mechanical-resonance frequency of approximately 100 kHz.

In summary, in embodiments of the present invention described above a workpiece of a transparent material is cut by focusing a beam of pulsed laser-radiation to a focus-location within the workpiece and translating the focus-location rapidly along an optical-axis while moving the workpiece continuously in a plane transverse to the optical-axis. The focus translation and workpiece motion creates an array of defects along a cutting line. The array of defects can have a saw-tooth pattern or a sinusoidal pattern. A variable-focus lens or mirror is combined with a fixed objective lens to focus the beam of laser-radiation and translate the focus-location rapidly along the optical-axis. The present invention is described above in terms of a preferred embodiment and other embodiments. The invention is not limited, however, to the embodiments described and depicted herein. Rather, the invention is limited only by the claims appended hereto.

What is claimed is:

1. A method for cutting a workpiece along a cutting path using a beam of pulsed laser-radiation from a source thereof, the beam of pulsed laser-radiation having an optical-axis, the beam of pulsed laser-radiation focused to a focus-location on the optical-axis, the method comprising:
translating the focus-location along the optical-axis between first and second opposite surfaces of the workpiece;
moving the workpiece continuously in a plane transverse to the optical-axis, such that the optical-axis follows the cutting path; and
wherein translating the focus-location within the moving workpiece creates a two-dimensional array of defects within the workpiece.

2. The method as recited in claim 1, wherein the defects do not overlap.

3. The method as recited in claim 1, wherein the array of defects has a saw-tooth pattern.

4. The method as recited in claim 1, wherein the array of defects has a sinusoidal pattern.

5. The method as recited in claim 1, wherein translating the focus-location along the optical-axis is accomplished using a variable-focus lens.

6. The method as recited in claim 1, wherein translating the focus-location along the optical-axis is accomplished using a variable-focus mirror.

7. The method as recited in claim 1, further comprising the step of separating the workpiece along the cutting line after the array of defects is formed.

8. The method as recited in claim 1, wherein the workpiece is of a material transparent to the beam of pulsed laser-radiation.

9. The method as recited in claim 1, wherein the workpiece is glass.

10. The method as recited in claim 1, wherein the pulsed laser-radiation has a pulse-duration less than about 20 picoseconds.

11. A method for cutting a workpiece along a cutting path using a beam of pulsed laser-radiation from a source thereof, the workpiece having first and second opposite surfaces, the beam of pulsed laser-radiation having an optical-axis, the method comprising:
moving the workpiece continuously in a plane transverse to the optical-axis, such that the optical-axis follows the cutting path;
focusing the beam of pulsed laser-radiation to a focus-location on the optical-axis and within the workpiece, the focus-location adjacent to the first surface for delivery of a first laser-radiation pulse;
translating the focus-location along the optical-axis towards the second surface during delivery of successive laser-radiation pulses, until a last laser-radiation pulse is delivered when the focus-location is adjacent to the second-surface;
refocusing the beam of pulsed laser-radiation, the focus-location within the workpiece and adjacent to the first surface for delivery of another first laser-radiation pulse; and
repeating the translating and refocusing steps while the optical-axis moves along the cutting path to create a two-dimensional array of defects within the workpiece.

12. The method as recited in claim 11, wherein the second surface of the workpiece is between the source of pulsed laser-radiation and the first surface of the workpiece.

13. The method as recited in claim 11, wherein the defects do not overlap.

14. The method as recited in claim 11, wherein translating the focus-location along the optical-axis and refocusing the beam of pulsed-laser radiation is accomplished using a variable-focus lens.

15. The method as recited in claim 11, wherein translating the focus-location along the optical-axis and refocusing the beam of pulsed-laser radiation is accomplished using a variable-focus mirror.

16. The method as recited in claim 11, further comprising the step of separating the workpiece along the cutting line after the array of defects is formed.

17. The method as recited in claim 11, wherein the workpiece is of a material transparent to the beam of pulsed laser-radiation.

18. The method as recited in claim 11, wherein the workpiece is glass.

19. The method as recited in claim 11, wherein the pulsed laser-radiation has a pulse-duration less than about 20 picoseconds.
